(19) United States
(12) Patent Application Publication
(10) Pub. No.: US 2024/0160832 A1
(43) Pub. Date: May 16, 2024

(54) Prevention of Web Scraping and Copy and Paste of Content by Font Obfuscation

(71) Applicants: George Mason University, Fairfax, VA (US); University of South Florida, Tampa, FL (US)

(72) Inventors: Mingkui Wei, Vienna, VA (US); Yao Liu, Tampa, FL (US); Zhuo Lu, Tampa, FL (US); Junjie Xiong, Tampa, FL (US)

(73) Assignees: George Mason University, Fairfax, VA (US); University of South Florida, Tampa, FL (US)

(21) Appl. No.: 18/508,366

(22) Filed: Nov. 14, 2023

Related U.S. Application Data
(60) Provisional application No. 63/425,469, filed on Nov. 15, 2022.

(51) Int. Cl. G06F 40/109

(52) U.S. Cl. CPC G06F 40/109

(57) ABSTRACT

A method and system provide and utilize obfuscated fonts for displayable content. Responsive to a request for displayable content having text, a text portion of the requested displayable content to be obfuscated is determined. For that text portion, obfuscated fonts are provided, by retrieving obfuscated fonts or by generating obfuscated fonts from a set of obfuscated glyphs created from a plurality of glyphs representative of a plurality of characters of the text portion of the displayable content. The obfuscated fonts can be created by assigning obfuscated glyphs of the set into the obfuscated fonts in accordance with one or more messages. The obfuscated fonts are mapped by assigning a value to each obfuscated glyph in the set that is different from an original value of the glyph.

### BRIEF DESCRIPTION OF THE SEVERAL VIEWS OF THE DRAWINGS

FIG. 1 is an example of a remote font and a normal font from a font library, in accordance with various embodiments of the present disclosure.

FIGS. 2a and 2b depict examples of glyph slicing, in accordance with various embodiments of the present disclosure.

FIG. 3 depicts an example of a split set of obfuscated fonts, in accordance with various embodiments of the present disclosure.

FIGS. 4a and 4b depict examples of glyph noise, in accordance with various embodiments of the present disclosure.

FIG. 5 shows an example of glyph distortion, in accordance with various embodiments of the present disclosure.

FIG. 6 depicts an example of glyph interleaving, in accordance with various embodiments of the present disclosure.

FIG. 7 illustrates an example of a method flow of font obfuscation, in accordance with various embodiments of the present disclosure.

FIG. 8 shows an example of a method flow of font obfuscation, in accordance with various embodiments of the present disclosure.

FIG. 9 illustrates an example of a method flow of font obfuscation, in accordance with various embodiments of the present disclosure.

FIG. 10 shows an alternate example of a method flow of font obfuscation, in accordance with various embodiments of the present disclosure.

FIG. 11 shows an example of a method flow of font obfuscation used for preventing copying and pasting of content, in accordance with various embodiments of the present disclosure.

FIG. 12 illustrates an example controller and/or computing environment in which aspects of some of the embodiments of the present disclosure may be implemented, in accordance with embodiments of the present disclosure.

### DETAILED DESCRIPTION OF EMBODIMENTS

Embodiments of the present disclosure will now be described with reference to the drawing figures, in which like reference numerals refer to like parts throughout.

Combating Web Scraping by Font Obfuscation

Web scraping, also known as web crawling, extracts data from the world wide web, also known as the Internet, to fulfil data acquisition needs for individuals and businesses. Automatic tools, which are usually referred to as bots, web crawlers or crawlers, are used to find websites, download web pages, and extract data from web pages. Data of interest includes descriptions and prices of products, email addresses, phone numbers, news, articles, customer reviews, etc. Although data on Internet pages is public information, companies do not want data on their webpages to be crawled and abused without authorization, because this can cause uncertainties for their normal operation, the potential loss of customers and profits, and infringe their copyrights and other intellectual property. As such, website owners sometimes consider web scraping offensive due to privacy, commercial, and various other reasons. For example, E-commerce retailers are susceptible to web scraping, because it allows competitors to monitor a retailer's product lists and take unfavorable actions like price matching or undercutting, or even effortlessly creating new competing online directories based on the data scraped. American Airlines v. Farechase Inc, 4:02-cv-00904, 2003 (N.D. Tex.) is an example of a court case about web scraping, in which FareChase was accused of using bots to scrape the flight data from American Airline websites to enable its customers to easily compare online fares.

Limitations of Techniques Against Web Scraping

Techniques have been developed to deal with web scraping. Existing anti-scraping techniques analyze network traffic or user behavior to detect bots that are used to do web scraping. Specifically, network traffic-based methods use various fields of an incoming HTTP request to a website to determine if the request is sent by a bot or a human user and then responds to the request with different actions, e.g., blocking a bot but allowing a normal user to access to the website.

Such techniques include but are not limited to:
Examining the “User-Agent” header of an incoming request. If this header indicates that the user agent (i.e., the program that is used to issue the request) is not from a normal web browser typically used by a human user, the website may block the request.
Keeping track of the number of requests sent from a certain IP address within a certain time period, and stop responding to such requests if this number passes a threshold, e.g., 10 times within a minute.
Monitoring the behavior of a user to differentiate between a real human user and a bot. For example, a piece of JavaScript code is included in the webpage to detect mouse movement. Because a bot does not interact with the page using a mouse like a human user does, if mouse movement is detected, the JavaScript determines it is interacting with a human and subsequently allows the user to access the requested content.
More advanced behavior-based methods may rely on machine learning techniques to identify “abnormal” behaviors to detect a bot. For example, if a visitor browses many product pages of an e-commerce, i.e. online shopping, website within a short period of time but does not place any order, the machine learning algorithm may consider this as abnormal and apply countermeasures, such as asking the user to fill a CAPTCHA, or even blocking the user from visiting the website.

Limitations of Techniques Against Web Scraping

All these anti-scraping methods are usually implemented as part of intrusion detection systems, such as a Web Application Firewall. The main issue with these approaches is that they cannot achieve 100% accuracy in distinguishing between a bot and a human user, because a bot can modify the essential fields of a HTTP request or try to mimic human behavior like moving and clicking a mouse to bypass the detection. So, these approaches suffer from two typical detection errors, namely, misdetections and false alarms. A misdetection error happens when a bot is incorrectly identified as a normal user, and a false alarm error happens when a normal user is incorrectly identified as a bot. Both errors are inevitable and the likelihood of these errors depends on the sophistication of the bot and the capability of the firewall.

Other anti-scraping methods aim to prevent a bot from web scraping, rather than detecting and blocking a bot from web scraping. In such schemes, a visitor may be required to solve a challenge to access the contents of a website. A typical challenge is CAPTCHA and reCAPTCHA. However, such challenges can still be solved by bots with advanced capabilities. On the other hand, as a side-effect, these methods also bring inconvenience to a human user who may become irritated and give up visiting the website.

Recently, some websites started to use fonts to defend against web-scraping. Letters, digits, and special characters are encoded by encoding schemes like the American Standard Code for Information Interchange (ASCII), which maps a character to a binary value. For example, the character “A” is encoded into “0x41” (the hexadecimal representation of the binary value 100 0001) by ASCII. Based on the encoding schemes, fonts have been created to display text with different appearances to accommodate functional and cosmetic needs. A font essentially defines three attributes of a set of characters: the glyphs (i.e., the appearance of characters, such as the image “A”), the codes (a code is the binary value assigned to a character, e.g., 0x41), and the mappings between the codes and the glyphs (e.g., code 0x41 should use glyph “A”).

The mapping of a font can be easily manipulated by using existing font design tools. For instance, a normal font maps the code 0x41 to the glyph “A”, and such mapping can be changed to map the same code to the glyph “B” or “C”, or any other glyphs. The premise of this font-based anti-scraping method is to use a font of manipulated mapping to render the web page content that the website owner does not want a bot to scrape. For example, if the website owner wants a human visitor to read “apple” but does not want a bot to see this word, he can then use a manipulated font that maps the code of “x” (0x78) to the glyph of “a”, the code of “y” (0x79) to the glyph of “p”, the code of “m” (0x6D) to the glyph of “I”, and the code of “k” (0x6B) to the glyph of “e”.

When a request that requests this information is received by the website server, the server will respond with the code string 0x78 0x79 0x79 0x6D 0x6B, and it will also specify these code be displayed using the manipulated font. For a bot that solely relies on the ASCII encoding scheme to interpret the code string, it will interpret the code string as the characters “xyymk”. For a web browser used by a human being, however, it will display the code string according to the code-glyph mapping specified in the manipulated font. Thus, “apple” will be displayed on the screen. Such a method attempts to “confuse” a bot rather than “detect-and-block” it, and can overcome the drawbacks of previous methods by eliminating misdetections and false alarms while ensuring a positive user experience.

Note that characters on a web page can be displayed using either a browser's default fonts locally installed on the computer, or fonts that are fetched from a remote server. The manipulated fonts described above need to be hosted remotely on a server that the website specifies. Whenever a user visits this website, the user's browser will download the manipulated fonts from the server, and these fonts are used to render the web page content that the website owner wants to hide from a bot.

This method, however, can be easily defeated by using a computer program that automatically inspects font files.

In an early approach, the web server uses scrambled-but-fixed font to display its content. For example, the web server always maps the code 0x41, the ASCII code of “A”, to the glyph “B” for all the requests. To bypass this approach, the bot developer can manually inspect the font file to find the scrambled mapping. After this step, when the bot crawls the code 0x41, it knows that this code stands for the letter “B” instead of “A” and can therefore do the substitution automatically.

To make web crawling harder, later approaches use font files with random mapping that differs for each request, i.e., the code 0x41 will be mapped to different glyphs for different requests. This approach makes manual inspection less effective because the inspection results apply to one request only. For a different request, the mapping changes and the inspection should be conducted again. Such an approach, however, can still be bypassed by a bot or crawler with a bit more effort.

There are generally two approaches that can be used to bypass the random font-based anti-scraping techniques. The first approach relies on the Optical Character Recognition (OCR) technology to read the font file and identify which code is actually mapped to which glyph. In the second approach, a bot developer can use software tools to extract the codes, glyphs, and the coordinates of each glyph of a font. The coordinate of a glyph is the x- and y-positions of multiple dots, which are used to depict the contour of the image of a character on a 2D plane.

An example glyph of letter “a” is displayed above, and the following information can be retrieved from a font file:
Code: 0x41
Glyph: “a”
Coordinates: (x1=14, y1=89), (x2=45, y2=70), . . . , (xn=100, yn=37)

The bot can first build a ground truth font library from two sources. The first source can be popular fonts like Times New Roman, Calibri, Arial, etc. The second source can be a font file that is directly fetched from the target web site (i.e., the web site to be crawled). To build the ground truth font library, the bot developer will manually inspect and record the coordinates of each glyph of each font.

In the next step, the bot will crawl the target web site to obtain both the code and the manipulated fonts with random mappings. The bot then compares the glyph coordinates in each fetched font with those in each font in the ground truth library to find matches.

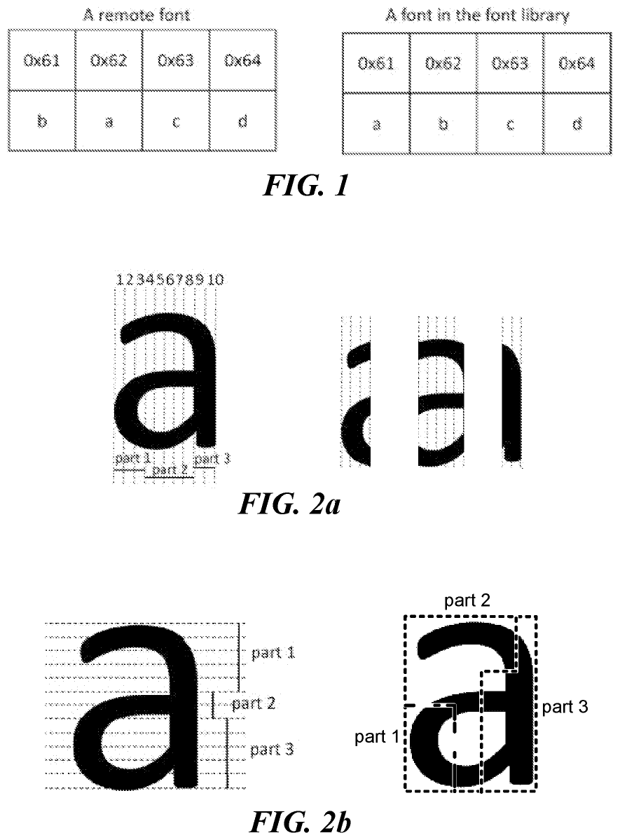

Consider, for example, a remote font that contains 4 characters as shown in FIG. 1. This font is a manipulated font, because ASCII codes encodes 0x61 and 0x62 into the characters “a” and “b, respectively, while in this font the codes of 0x61 and 0x62 are mapped with glyphs of “b” and “a”, respectively. For this remote font, the bot compares the glyph coordinates of 0x61 with those of each character of each font in the font library. The bots can finally find that the coordinates of 0x61 in the remote font file match the coordinates of 0x62 in the ground truth font library. As a result, the bot knows that for this font, the code 0x61 corresponds to the character “b” instead. The bot can use the similar method to examine the rest of characters of this remote font to do the calibration. Reference is made to FIG. 1 of the drawings in which examples of a remote font and a normal front from the font library are shown.

Note that even though the mapping between codes and glyphs can randomly change on each request, the glyph coordinates remain unchanged because the website always use the same set of glyphs and only manipulate the mappings between codes and glyphs. Therefore, the attacker can always use this method to automatically find the correct code-glyph mapping of a scrapped character, thereby bypassing the existing font based anti-scraping method.

Also note that slightly modifying the coordinate of one or multiple dots is not an effective approach to bypass this method. The bot can still find the correct glyph by calculating the difference (e.g., Euclidean distance) between a glyph in the remote font and all the glyphs in the ground truth library and find the one that has the smallest value.

Combating Web Scraping by Font Obfuscation

As recited in this disclosure, various embodiments provide a novel method and system to combat web scraping. A fundamental reason for the failure of the described font based anti-scraping is that it manipulates the mapping only but does not attempt to obfuscate the glyphs. This makes the coordinates of a glyph constant, or slightly vary, allowing such a glyph to be easily matched to a glyph in the ground truth font library. To create an effective web scraping tool, not only is mapping manipulated but glyphs are also obfuscated. Fonts of manipulated mapping and obfuscated glyphs are referred to as obfuscated fonts.

There are many methods to create obfuscated fonts. One can easily come up with a naïve method that slightly changes the coordinates of a glyph (i.e., a misshaped glyph), such that they are no longer the same as their counterparts in the font library and meanwhile can still be recognized by human eyes. Nevertheless, the bot can compare the difference between glyphs and find the closest match. Specifically, for a character scraped from the web page and rendered by a misshaped glyph, the bot can calculate the Euclidean distance, or other mathematical metrics, that can quantify the difference between the glyph of this rendered character and the glyphs from a library the includes normal fonts. The normal character that leads to the smallest difference is highly likely to be the misshaped glyph. Moreover, OCR techniques can always be used to read a font and identify the correct code for each glyph.

It is also noteworthy that because the glyph is to be displayed and read by a human being, it cannot be heavily altered. For example, while a heavily distorted character like the ones usually seen in a CAPTCHA may evade OCR, it will also irritate a human user and reduce his web-browsing experience. Therefore, heavily altering the glyph to evade OCR or coordinate-comparison is not a feasible solution.

Accordingly, more in-depth obfuscation is used to change the glyphs in a way that the bot cannot use all the above-mentioned approaches to find the correct characters, while those characters still appear normal to human eyes. One possible method is to randomly slice a glyph. For example, as shown the example glyph slice in FIG. 2a, the glyph of the character “a” is divided into 10 small chunks, and then “a” is randomly sliced into three parts that cover chunks 1 to 3, 4 to 8, and 9 to 10, respectively.

Note that this example illustrates but one way to slice a glyph, and other ways of slicing are contemplated and described within this disclosure. Descriptions of ways to slice glyphs are provided by way of example and are not meant to be limiting. Accordingly, any method that can appropriately split a glyph can be used to create the obfuscated fonts.

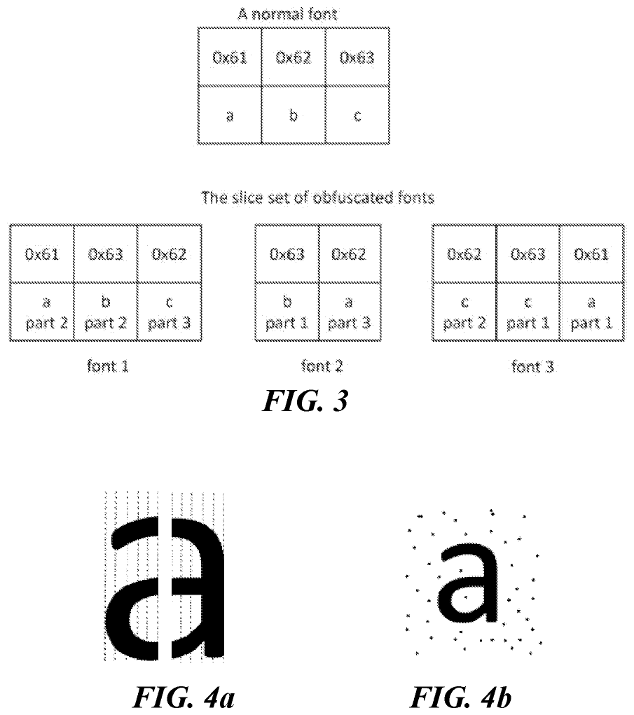

After splitting, an obfuscated font is created in the following way. Assume that a normal font includes a tiny alphabet of 3 letters, which are “a”, “b”, and “c”. Further assume that they are each split into 3, 2, and 3 parts, respectively. This means that there is a total of 8 (i.e., 3+2+3) glyphs that are generated from the split. Three new fonts, which include 3, 2, and 3 glyphs, respectively, are then created, as shown in FIG. 3, which illustrates an example of a split set with obfuscated fonts. Note that the number of new fonts and the number of glyphs included in each new font are not fixed values. One can create more or less fonts of different sizes, as long as they together cover the 8 glyphs.

The set formed by these obfuscated fonts generated from splitting characters is referred to as the slice set, in the case of slicing. In this example, fonts 1, 2, and 3 form the slice set. The 8 glyphs are filled in, i.e., parts 1, 2, and 3 for “a”, parts 1 and 2 for “b”, and parts 1, 2, and 3 for “c”, in the three fonts in a random way as shown in FIG. 3. For each glyph in each font, a value, such as a code, is then randomly assigned. For instance, as shown in FIG. 3, in font 2, part 1 of “b” and part 3 of “a” are mapped to 0x63 and 0x62, respectively. To display a character to a human user, multiple glyphs from multiple obfuscated fonts may need to be used in the same slice set. For example, codes 0x61 from font 3, 0x61 from font 2, and 0x62 from font 2, together, render the character “a” on the screen of a computer.

To further confuse a bot, obfuscated fonts are randomized. For example, to create a slice set of obfuscated fonts, for each character that should be covered by this set, the way to slice the glyph of this character is randomly selected, e.g., the number of chunks that divide the glyph of this character, as well as the number of parts that slice the glyph. Also the way to fill the glyphs into the obfuscated fonts is randomly selected, as is the number of obfuscated fonts in the slice set, the number of glyphs included in each font, and the code for each glyph in each font. When a user visits a website that uses obfuscated fonts, the website randomly creates a slice set of obfuscated fonts to render the web page content that the website owner wants to hide from a bot. For efficiency purposes, the website may also pre-generate a pool of many different slice sets, and randomly picks one or more sets from the pool to render the web page content.

An advantage of this approach is that each glyph only contains a part of a character, which may be a vertical or horizontal line, a curve, an arch, a dot, etc. Because each glyph contains only a portion of a character, it will be very challenging for OCR to recognize any valid characters and coordination-matching will fail too due to the split and randomization. From the perspective of human perception, a human user will not see any discrepancy because all glyphs put together still form a complete character.

As mentioned earlier, there are other ways to slice a glyph. For examples, a glyph can also be sliced horizontally or even irregularly into geometric shapes other than vertically as shown in FIGS. 2a and 2b, in which horizontal slicing and irregular shape slicing, respectively, are illustrated.

In addition to glyph slicing, so-called glyph noise can be introduced to make OCR ineffective. As shown in FIG. 4a, “spacers”, i.e., white spaces between two or multiple parts, may be inserted as shown. Inserting such white space between two or more parts of a letter will not create any recognition barrier to a normal human user but will significantly confuse machine learning based OCR algorithms, for example. Another way to introduce glyph noise is through the addition of dot noise. As shown in FIG. 4b, the glyph letter “a” is accompanied by dotted noises. Suh added noise does not pose any readability issues to a human being but can render OCR ineffective.

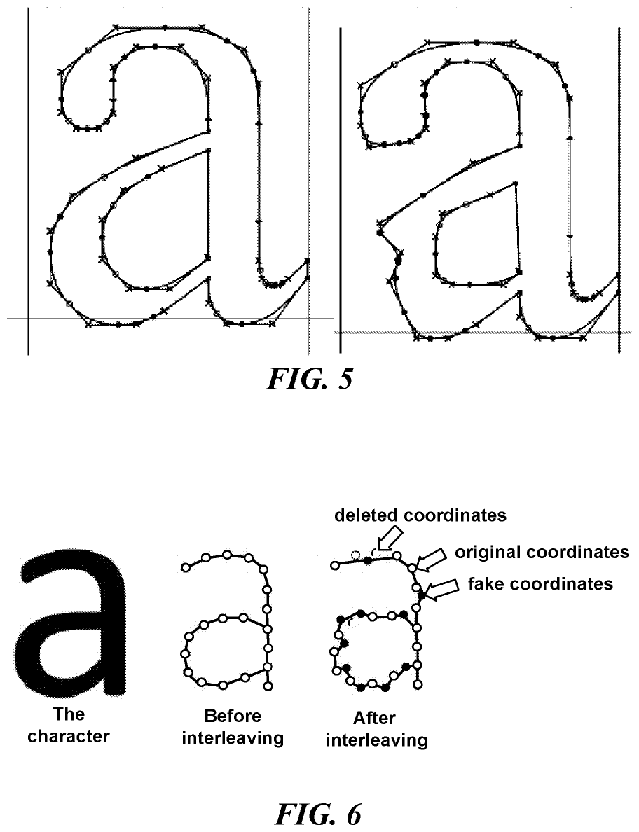

In addition to glyph slicing and glyph noise, glyph distortion can also be employed. As shown in FIG. 5, the glyph “a” is shown before and after an example distortion. Distortion of the shape of a character makes OCR ineffective.

In addition to slicing, other ways to create obfuscated fonts are contemplated. For example, the coordinates of a glyph can be directly changed, or in other embodiments, obfuscated fonts are created by interleaving “fake” coordinates with the original coordinates of the glyph of a character to confuse a bot. For instance, as shown in FIG. 6, the original coordinates are interleaved with the fake coordinates, and some of the original coordinates are dropped to make the new glyph look similar to the original one. These fake coordinates should be created in a way that the bot cannot easily identify the original character after interleaving. Again, as mentioned earlier, any method that can effectively change glyphs making it less easy for a bot to identify the correct glyph can be used to create obfuscated fonts and is contemplated herein.

Using Obfuscated Fonts for Purposes Other than Anti-Scraping

These embodiments against web scraping can be further advanced in the following aspects. Web site owners may want to specify the underlying content that a bot sees. A randomly scrambled mapping will let a human user see the correct content, while a bot will see garbled text, which may be sufficient for anti-scraping. However, a web site owner may also want to specify the content, i.e., let the bot crawl some meaningful content, for two reasons.

First, letting the bot see sensible content rather than garbled information can further confuse the bot. For instance, if the content is “four apples”, and the bot sees “dxau apple”, the bot may be able to detect such inconsistencies and further realize that the web site has applied font-based anti-crawling. However, if the garbled content becomes “five apples”, the bot will not detect an abnormality. If the bot turns to human effort to manually interpret the scraped content, the cost of web crawling can be significantly boosted.

Second, the web site owner can even add a “water mark” to content by utilizing the methodology and systems described herein. For instance, the web site owner can use carefully designed fonts to map a few characters in a web page to be related to the web page requestor's identity. For example, assume the original web page contains numbers 123456123456. And a request that asks for this page is from an IP address of 100.101.102.103. The web site owner can generate a font that maps the numbers 100101102103 (the IP address) to be displayed as 123456123456. If the request is sent by a human user, the user will still see 123456123456. If the request is sent by a bot and the crawled content is later posted online, the web site owner can use the posted content, i.e., 100101102103, to trace back to the IP address that has launched the crawling.

As another example, an online shopping website is selling a product at the price $69, and the website owner wants a web bot to obtain a fake price of $12. The ASCII codes of the characters “1” and “2” are 0x31 and 0x32, respectively. The web owner can create an obfuscated font that splits 6 into two glyphs, with one mapping to the code 0x31 and the other to the code 0x32. The digit “9” is simply mapped to a special character like 0x20 (the code for the space character). As a result, the bot will obtain the code string 0x31 0x32 0x20, discard the special character, and interpret the price as $12. A human user, on the other hand, will still see the price displayed as $69.

To track a bot, the obfuscated fonts that are unique to each requesting-entity suspected to be a bot are generated so that the suspected entity can be tracked. Such an entity can be identified, for example, by the IP address where the request is sent, or any unique values in the request header. For example, if two requests, sent from IP addresses of 1.1.1.1 and 2.2.2.2, are suspected to be from bots, two different obfuscated fonts for the two IP addresses, respectively, can be used. In the font to be used by 1.1.1.1, assume that the digit “6” is split into two glyphs and no split for the digit “9”, the codes of “1” and “2” are mapped to the glyphs of “6” and “9”. In the font to be used by 2.2.2.2, the codes of “3” and “4” are mapped to the glyphs of “6” and “9”. Meanwhile, the mapping that “1” and “2” are linked to the IP of 1.1.1.1, and that “3” and “4” are linked to the IP 2.2.2.2 are stored. If both 1.1.1.1 and 2.2.2.2 are human users, they will both see the correct price of $69. However, if either one or both are bots, the bot will read the codes and interpret the price as $12 and $34, respectively. Later, if a price-comparing website that lists the price of the product on the shopping website is $12, it is known that their bot has the IP address 1.1.1.1 and more restrictive measures can be taken to prevent this IP address from scraping the shopping website.

Note that the examples contained herein are based on English. However, the general principles and ideas of this disclosure can be applied to all other languages as long as its characters have been encoded and can be displayed on a computer.

Good Crawlers

Crawlers are not all bad, and some are advantageous. For example, some crawlers crawl all available web sites and index them, and such indexed information will be used to fulfill robust searches. A general concern of using the font-based anti-scraping techniques lie in that such good crawlers will also see garbled content and thus will not rank the website according to its real content. This concern can be addressed from two approaches.

First, the web site owner can maintain an allow-list, which contains the good crawler's IP addresses. If a request is sent from these IP addresses, the web site will simply respond with the original content without using obfuscated fonts.

Second, parameters that are used to randomize obfuscated fonts can be shared with good crawlers, such that these crawlers can recover the original content directly. As mentioned earlier, example parameters may be shared by messages such as code strings and may include the number of chunks that divide the glyph of this character, the number of parts that split the glyph, the way to fill the glyphs into the obfuscated fonts, the number of obfuscated fonts in the splice set, the number of glyphs included in each font, the code for each glyph in each font, etc.

Alternatively, the randomization parameters can be generated using a cryptography algorithm of inputs related with the requestor's identity, such as the IP address, as well as a secret key that is shared between the website and the good crawler. The algorithms for font randomization and parameter generation can be public and open-sourced. The web site owner only needs to share a secret key with a good crawler, which will be able to recover the original web page content based on its own IP address and the shared secret key. This approach does not require the web site owner to maintain an allow-list of IP addresses and thus it is resilient against the IP address spoofing attacks.

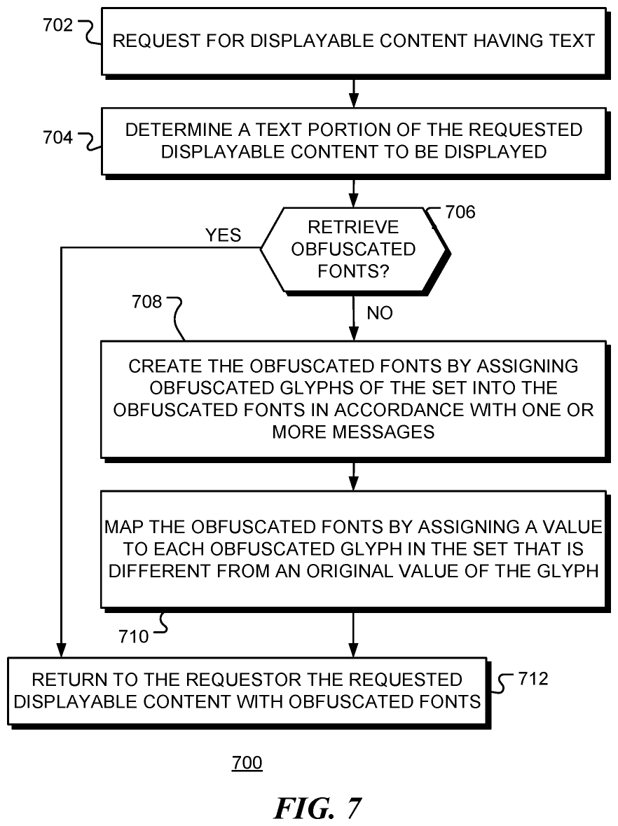

Referring now to FIG. 7, an example method flow 700 in accordance with the obfuscation techniques is presented. At block 702, a requestor, which may be a human user, a bot or a crawler, requests displayable content having text. At Block 704, a text portion of the requested displayable content to be obfuscated is determined. The obfuscated fonts needed to render the requested content may be either retrieved or generated, as determined at decision block 706. If the obfuscated fonts are to be retrieved, the flow continues to block 712 where the requested displayable content is returned to the requestor. If the obfuscated fonts are to be generated, at block 708 obfuscated fonts are generated from a set of obfuscated glyphs created from a glyphs representative of characters of the text portion of the displayable content in accordance with messages or communications communicated as will be described herein. At block 710, the obfuscated fonts are mapped by assigning a value to each obfuscated glyph in the set that is different from an original value of the glyph.

The following embodiments are combinable.

Therefore, in one embodiment of the disclosure, an example method is provided. Responsive to a request for displayable content having text, a text portion of the requested displayable content to be obfuscated is determined and obfuscated fonts are provided by generating the obfuscated fonts from a set of obfuscated glyphs created from a glyphs representative of characters of the text portion of the displayable content. Generating the obfuscated fonts includes creating the obfuscated fonts by assigning the obfuscated glyphs of the set into the obfuscated fonts in accordance with messages and mapping the obfuscated fonts by assigning a value to each obfuscated glyph in the set that is different from an original value of the glyph.

In another embodiment of the method, characters of displayable content are mapped to an identity indicator of a requestor of the displayable content. In various embodiments, the identity indicator is an IP address associated with the requestor or information in a request header of a request sent by the requestor.

In another embodiment of the method, determining that the request for the displayable content is from an approved requestor, not creating the plurality of obfuscated fonts, and providing the displayable content to the approved requestor without obfuscation of the displayable content.

In another embodiment of the method, determining that the request for the displayable content is from an approved requestor and providing the plurality of obfuscated fonts and the one or more messages associated with the obfuscated fonts to the approved requestor.

In another embodiment of the method, rendering the requested displayable content for display in accordance with the obfuscated fonts.

In another embodiment of the method, the messages include a number of chunks into which each glyph of the glyphs are to be divided, how the obfuscated glyphs fill the obfuscated fonts, a number of obfuscated glyphs of the set of obfuscated glyphs, a number of obfuscated glyphs in each obfuscated font, or a value for each obfuscated glyph in each obfuscated font.

In another embodiment of the method, a server generating the messages using an identity indicator of a requestor of the displayable content or a shared key between the server and a font server. In accordance with further embodiments, the requestor is an approved requestor and the server sharing with the requestor the shared key between the server and the font server, where the requestor can access the displayable content without obfuscated fonts using the identity indicator of the requestor and the shared key. In still further embodiments, the identity indicator is an IP address associated with the requestor or information in a request header of a request sent by the requestor.

In another embodiment of the method, a server communicating to a font server the text portion of the requested displayable content to be obfuscated and determining the one or more messages.

In another embodiment of the method, slicing the plurality of glyphs representative of the characters to create a slice set of obfuscated glyphs, with each slice in the slice set representative of a portion of a character of the characters.

In another embodiment of the method, further selecting how each glyph of the one or more glyphs is sliced, including selecting the number of slices in the slice set and selecting the number of obfuscated fonts of the obfuscated fonts in accordance with the one or more messages.

In another embodiment of the method, slicing includes vertically slicing, horizontally slicing, irregular shape slicing or inserting spaces into one or more glyphs of the plurality of glyphs.

In another embodiment of the method, the slice set of obfuscated glyphs is chosen from a plurality of slice sets of obfuscated glyphs in accordance with the one or more messages.

In another embodiment of the method, each glyph has coordinates that define the glyph and creating the set of obfuscated glyphs includes manipulating the coordinates of one or more of the glyphs.

In another embodiment of the method of the disclosure, manipulating the coordinates of one or more of the glyphs includes changing the coordinates of one or more of the glyphs and interleaving the coordinates of one or more of the glyphs. In further embodiments, interleaving a glyph of the plurality of glyphs includes interleaving fake coordinates with original coordinates of the glyph. In still further embodiments of the method of the disclosure, dropping one or more original coordinates of the glyph.

In another embodiment of the disclosure, the obfuscated fonts are part of a collection of obfuscated and nonobfuscated glyphs.

In another embodiment of the disclosure, the value assigned to each obfuscated glyph is a code.

In another embodiment of the disclosure, the obfuscated fonts were previously generated and stored and providing the obfuscated fonts includes retrieving the obfuscated fonts from storage.

The following embodiments are combinable.

Embodiments of the present disclosure advantageously provide a system having a server and a font server coupled in cooperative communication with the server. The server may be a content server, a data server, or a web server. It is understood and envisioned that the server and the font server described herein may be the same server, server and font server portions that reside on a server, or separate servers.

In response to a request from a requestor, such as a human user, a crawler or web crawler, or a bot, for displayable content having text, the server determines a text portion of the requested displayable content to be obfuscated. The server or the font server provide a plurality of obfuscated fonts. In some embodiments, the obfuscated fonts are retrieved, such as from system memory, database storage or the like. In other embodiments, the obfuscated fonts are generated from a set of obfuscated glyphs that are created from glyphs representative of characters of the text portion of the displayable content. More particularly, the obfuscated fonts are created by assigning the obfuscated glyphs of the set into the obfuscated fonts. The obfuscated fonts are mapped by assigning a value to each obfuscated glyph in the set that is different from an original value of the glyph.

In certain embodiments of the disclosure, messages or communications between the server and the font server instruct the server and/or the font server how to generate the obfuscated fonts o. As described herein, the message may be one or more code strings, instructions or the like that provide direction on how to provide the obfuscated fonts in response to the request.

In another embodiment of the disclosure, responsive to receipt of the messages and a request for the obfuscated fonts from the requestor, the font server provides the obfuscated fonts to the requestor, such as by generating the obfuscated fonts in accordance with the messages.

In other embodiments of the disclosure, the server or the font server generates the obfuscated fonts from the set of obfuscated glyphs in accordance with the messages between the server and the font server.

In another embodiment of the disclosure, the font server slices the glyphs representative of the characters to create a slice set of obfuscated glyphs, with each slice in the slice set representative of a portion of a character of the plurality of characters.

In another embodiments of the disclosure, the font server selects how each glyph of the one or more glyphs is sliced, including selecting the number of slices in the slice set and selecting the number of obfuscated fonts of the plurality of obfuscated fonts in accordance with the messages. In accordance with certain embodiments, the font server slices the glyphs by vertically slicing, horizontally slicing, irregular shape slicing and inserting spaces into one or more glyphs of a plurality of glyphs.

In another embodiment of the disclosure, the slice set of obfuscated glyphs is chosen from slice sets of obfuscated glyphs in accordance with the one or more messages.

In another embodiment of the disclosure, each glyph of the glyphs has coordinates that define the glyph and the font server creates the set of obfuscated glyphs by manipulating the coordinates of one or more of the glyphs.

In another embodiment of the disclosure, the font server manipulates the coordinates of one or more of the glyphs by changing the coordinates of one or more glyphs and interleaves the coordinates of one or more of the glyphs.

In another embodiment of the disclosure, interleaving a glyph of the plurality of glyphs includes interleaving fake coordinates with original coordinates of the glyph. In a further embodiment, interleaving includes dropping one or more original coordinates of the glyph.

In another embodiment of the disclosure, the server determines messages used by the font server to generate the plurality of obfuscated fonts. In a further embodiment of the system, the server determines the messages based on an identity indicator of a requestor of the request for displayable content and a shared key between the server and the font server.

In another embodiment of the disclosure, the requestor is an approved requestor that can access the displayable content without obfuscated fonts using the identity indicator and the shared key provided to the requestor.

In another embodiment of the disclosure, the identity indicator is an IP address associated with the requestor or information in a request header of a request sent by the requestor.

In another embodiment of the disclosure, the font server assigns the obfuscated glyphs of the set into the obfuscated fonts in accordance with the messages and maps the obfuscated fonts by assigning the value to each obfuscated glyph in the set.

In another embodiment of the disclosure, the messages include one or more of a number of chunks into which each glyph of the glyphs are to be divided, how the obfuscated glyphs fill the plurality of obfuscated fonts, a number of obfuscated glyphs of the set of obfuscated glyphs, a number of obfuscated glyphs in each obfuscated font, and the value for each obfuscated glyph in each obfuscated font.

In another embodiment of the disclosure, in response to a request from the requestor for displayable content, the server communicates to the font server the text portion of the requested displayable content to be obfuscated and the font server generates the obfuscated fonts in accordance with the messages.

In another embodiment of the disclosure, the font generator provide the obfuscated fonts and the requested text portion as obfuscated text to the requestor.

In another embodiment of the disclosure, the obfuscated fonts map the obfuscated text back to the unobfuscated text portion of the requested displayable content.

In another embodiment of the disclosure, the server instructs the requestor to request the plurality of obfuscated fonts and the displayable content from the font server.

In another embodiment of the disclosure, the server is a web server, the displayable content includes a web page, and the requested page is rendered for display to the requestor using the obfuscated fonts.

In another embodiment of the disclosure, the server and the font server are server and font server portions that reside on a single server or the server and the font server are the same server.

In another embodiment of the disclosure, the obfuscated fonts are part of a collection of obfuscated and nonobfuscated glyphs. In another embodiment, the obfuscated fonts were previously generated and stored and where the server or the font server provide the obfuscated fonts by retrieving the obfuscated fonts from storage.

In another embodiment of the disclosure, the value assigned to each obfuscated glyph is a code.

Example Flows for a Designed System

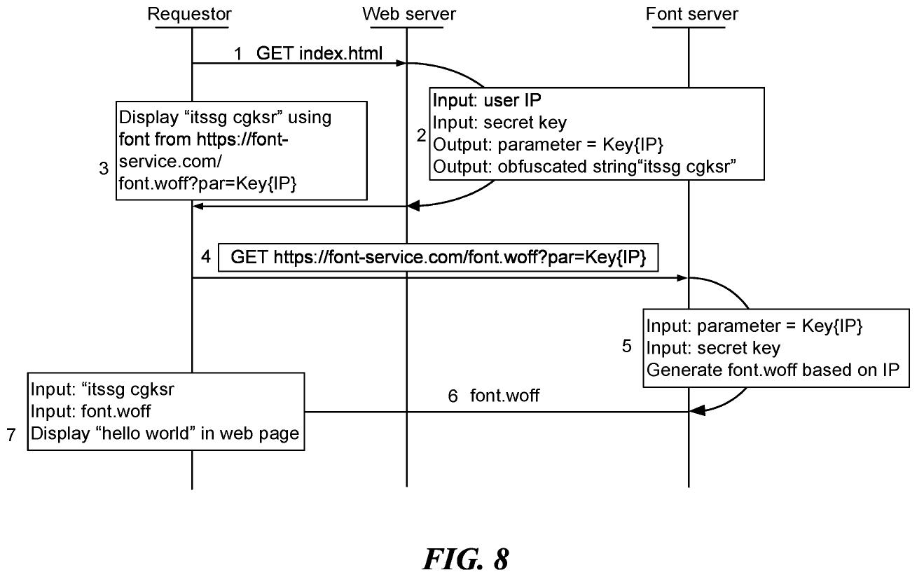

Example working flow charts of a system in accordance with various embodiments are illustrated in FIGS. 8-11. It is recognized that other implementations of the method and system described herein are contemplated; thus these two examples are provided as not to limit the application of the described embodiments.

In the description of these drawings, reference is made to a Web server, a Font server and a Requestor. While a web server is shown and described as a server that provides web pages to be displayed in a browser to a user, it is also contemplated that the server may be a content server or a data server. While the requestor may be a human user who requests data from the web server to display in an application, such as a web browser, it will be understood from the previous description that the requestor could be a crawler or a bot. Finally, while a font server is shown and described as providing obfuscated fonts, it is understood that obfuscated fonts may be provided in response to a request from either the Font server or the Web server.

The web server, or content or data server, may have already subscribed to a font obfuscation service from the font server, which establishes a shared secret key between the Web server and the Font server in this example embodiment. A shared secret key between the web server and the Font server may otherwise be established as well.

Referring now to the example flow of FIG. 8, in Action 1, the process starts by the user sending a request, such as a normal HTTP request as shown, to the web server to request displayable content, such as a web page, which includes text content that the Web server wants to obfuscate.

Based on the user's IP address, or any other identify related features that the web server chooses, in Action 2 the web server calculates the obfuscated code string. Then, based on the shared secret key, and the user's IP address, or any other identity related features that the web server chooses, the web server calculates the parameters (as mentioned earlier, the algorithms for font randomization is made public). The calculation result is a seemingly random string, which informs the font server in one or more messages the specific way to create obfuscated fonts or to find pre-created obfuscated fonts for this Web server. Note that while the result may be sent by the web server to the user as a message, the real algorithm and calculation need not be conducted on the web server only. The actual calculation can be carried on, for example, by a cloud-based server, a serverless edge server, or even the font server.

In Action 3, the web server sends the obfuscated code string, the location from where to retrieve the font file, and the parameters to the user.

Upon receiving the parameters from the web server, the user requests the obfuscated fonts from the font server and the parameters are attached to the user's request in Action 4.

In Action 5, the font server, based on the parameter and the shared secret key provided to it in one or more messages, creates the obfuscated fonts or finds the corresponding pre-created obfuscated fonts from its local database or other storage.

The font server sends the obfuscated fonts back to the user in the response in Action 6.

The requested data, such as a requested web page, is displayed in an application used to display the content, such as a web browser, in Action 7. If the obfuscated fonts are correctly generated, human eyes should see the text that the web site owner otherwise wants to hide from the bot. On the other hand, a crawler, who is unable to “see” the glyphs, will only obtain the codes that are fetched from the web server, and based on these codes it interprets garbled text.

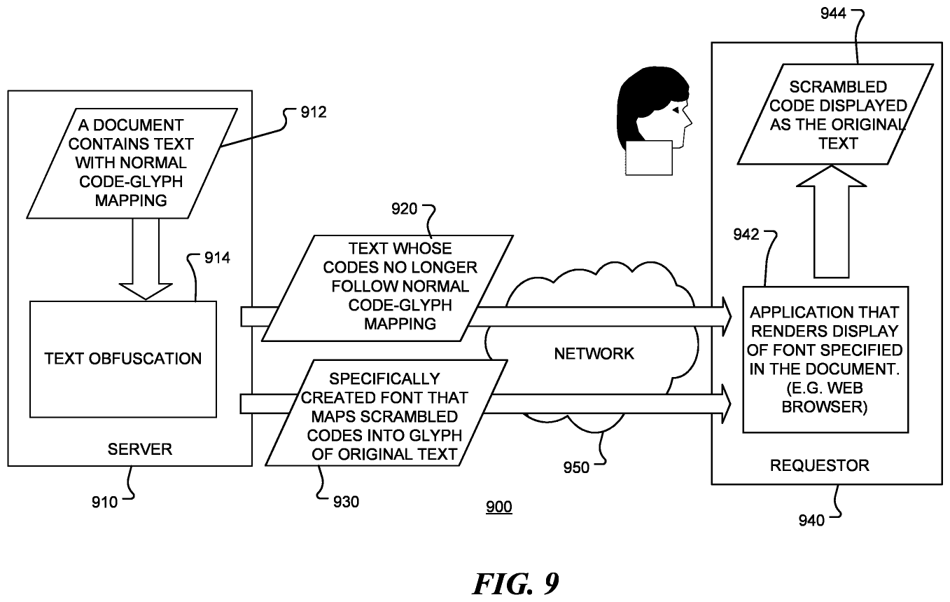

Referring now to FIG. 9, an example network system environment 900 is shown on which aspects of some embodiments may be implemented. The system 900 is comprised of server 910 and requestor 940 in communication over a network 950. As previously described, server 910 may comprise web server/content server/data server and font server functionalities that may reside on the same or separate servers, server portions. The server 910 has a document 912 that has original text with normal code-glyph mapping, which is provided to text obfuscation block that is controlled by the server. Text obfuscation block 914 provides two messages or other communications over the network 950 to requestor 940. The first communication 920 is text whose code no longer follows normal code-glyph mapping, having undergone the text obfuscation of block 912; as previously described this may be a message string, such as a code string. The second communication message 930 is a font file needed to render the text. The specifically created font maps scrambled codes into the glyphs of the original text. At the requestor side, an application, which as a web browser, receives messages 920 and 930 and is able to render for display 944 in the font specified in the document.

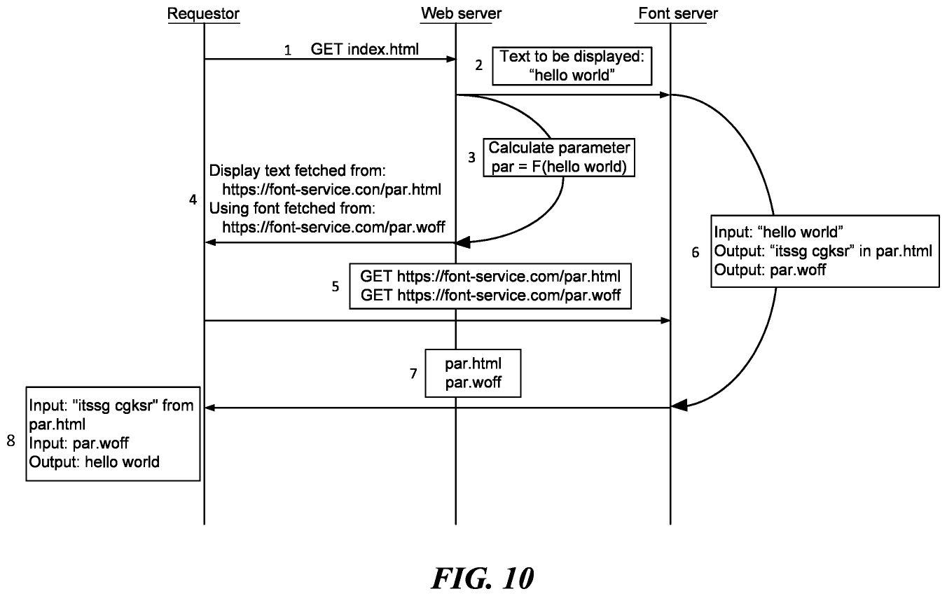

Referring now to FIG. 10, another example implementation is shown in the flow chart. In Action 1, the process starts by the user sending a request to the server to request displayable content, which includes the text content that the server wants to obfuscate. As indicated in this particular example, the user can send a normal HTTP request to a web server. As indicated previously, the server can also be a content server, data server, etc.

The web server informs the font server via one or more messages the text that should be hidden in Action 2.

In Action 3, the web server calculates a parameter that uniquely identifies the text based on the text content. For example, a Hash function can be used.

The web server does not directly respond with any text content. Instead, in Action 4 the server informs the user via a message or other communication to obtain the text from the font server. Also, in Action 4 the web server informs the user via messages to obtain a font file from the font server to render the text. Both the text file and the font file are associated with the unique id determined in Action 3, based on which the Font server can recognize the specific data server.

The user sends two requests via messages to the Font server, requesting the text and the font file in Action 5.

Action 6 happens after Action 2 and in parallel with Actions 3, 4, and 5. When the font server receives the to-be-hidden text, it generates the obfuscated text, as well as the font file that maps the obfuscated text back to the original text.

Upon receiving the requests in Action 5, the font server responds with the text content and the font file in Action 7.

In Action 8, the user receives the obfuscated text, as well as the specially designed font file. The requested data, such as a web page, is displayed in an application that is used to display the content, such as a web browser. If the obfuscated fonts are correctly generated, human eyes should see the text that an owner of the data, such as a Web site owner or data server owner, otherwise wants to hide from the bot. On the other hand, a crawler, that is unable to “see” the glyphs, will only obtain the codes that are fetched from the server, and based on these codes it interprets garbled text.

Preventing Copy-and-Paste of Web Content by Font Obfuscation

While a website and its content published in a web page fall in the public domain, its contents are still copyright-protected and should not be freely copied and republished somewhere else without proper authorization.

However, in the cyber world, web page content piracy is quite common. This is because copy-and-paste is all a person needs to do to duplicate the content. On the other hand, preventing such easy copy-and-paste type of piracy is non-trivial.

Some techniques to protect copyrighted materials include the following methods:
Display copyright to warn the person who wants to copy the content. However, this does not stop those who are dedicated to copy the content.
Use JavaScript to either block Right-click or Copy/Paste functions when a web page is opened. Such an approach only blocks a lay person who does not have any technical knowledge and is easily bypassed with some technical skill.

The disclosed improvements of this disclosure protect web page content by using a completely different approach. When the improved technology is applied, a human user views the content of a web page as usual; however, when the content is selected, copied and pasted somewhere else, the user only obtains garbled data instead of the content displayed in the web page.

The embodiments disclosed herein leverage m is-matched codes and glyphs of a font.

As previously described, in the context of computers, letters, digits, and special characters, etc. are encoded by encoding schemes like the American Standard Code for Information Interchange (ASCII), which maps a character to a binary value. For example, the character “A” is encoded into “0x41” (the hexadecimal representation of the binary 100 0001) by ASCII. Based on the encoding schemes, fonts have been created to display text with different appearances to accommodate functional and cosmetic needs. A font essentially defines three attributes of a set of characters: the glyphs (i.e., the appearance of characters, such as the image “A”), the codes (e.g., 0x41), and the mapping between the codes and the glyphs (e.g., code 0x41 should be displayed using glyph “A”).

The mapping of a font is easily manipulated by using existing font design tools. For instance, a normal font maps the code 0x41 to the glyph “A,” while this code is changed to map to the glyph “B” or “C”, or any other glyphs. Essentially, a computer recognizes a character by reading its code, while a human being will recognize the glyph. The embodiments of this disclosure disrupt the “standard” mapping between codes and glyphs so that a human user and computer will recognize a character differently.

For example, if the website owner wants a human visitor be able to read the word “apple” on the web page, but does not want the word to be copied-and-pasted, the website owner creates a specific font that maps the code of “x” (0x78) to the glyph of “a,” the code of “y” (0x79) to the glyph of “p,” the code of “m” (0x6D) to the glyph of “l,” and the code of “k” (0x6B) to the glyph of “e.”

When the web page is being requested and displayed by a web browser, the web server sends the code string 0x78 0x79 0x79 0x6D 0x6B and instruct the web browser to display this code string using the specifically designed font.

Note that characters on a web page are displayed using a font that is either locally installed on the computer, or fetched from a remote server. The specifically designed fonts described above are preferably hosted on a remote server, and the web server uses commands, such as styling sheets, to instruct the browser to download and use this font instead of using any local fonts.

As a result, when the code string is displayed by the web browser for a human user to read, it follows the specifically designed font and displays the code 0x78 to letter “a”, 0x79 to letter “p”, and so forth.

When such a code string is copied and pasted to a different text editor, however, since the other text editor is not aware of such disrupted code-glyph mapping, it displays the glyphs that are supposed to be used according to the “standard,” such as ASCII, and displays it as “xyymk” instead. This action effectively achieves the objective that while a human user can read the content as usual, they cannot copy-and-paste any content displayed in the webpage.

The above-described techniques of glyph manipulation, including glyph slicing, glyph noise, glyph distortion, etc. shown in FIGS. 1-6, may be further applied to confound the use of OCR and human manual inspection as work-arounds. As previously described, OCR is usually a machine learning-based algorithm that allows a computer to “read” an article and extract characters automatically. In the above-mentioned example, even though a human being is unable to directly copy-and-paste the content of a web page, they can use OCR to read and recognize and extract characters. OCR may be used against either the web page directly or the font file. When being used against the web page, OCR is used to read the article and extract its content directly. When being used against the font file, the OCR is used to read the font file, and recognize the mapping between a code and its corresponding glyph. For example, in the above-mentioned example, the OCR is used to find that code 0x78 is mapped to the letter “a.” Once such disrupted mapping is identified, tools are developed to map all code 0x78 contained in the web page into letter “a.”

Alternately, a human user may manually inspect the font file and find the mapping. A font file may be opened and inspected using available applications, such as font editors, such as open source FontForge, for example. Based on the above example, a user could download the specifically designed font file, open it, and identify that the code 0x78 is mapped to the letter “a.” And once such mapping is identified, tools may then be developed to map all code 0x78 into letter “a.”

In accordance with various embodiments described herein, the various types of glyph distortion may be employed to block those two approaches to unauthorized copy-and-pasting of web content.

Glyph slicing: Instead of letting one glyph display one complete character, in accordance with embodiments described herein, one glyph displays a part of a character, and each part of the glyph is assigned or given different codes. For example, in FIG. 2a, letter “a” is sliced into three parts and given codes 0x01, 0x02, and 0x03, respectively. And if the letter “a” is to be displayed, the code string 0x01 0x02 0x03 is sent altogether. This approach significantly increases the cost of manual inspection. Note the font may be sliced in any direction in irregular shape slicing, as shown in FIG. 2b.

Glyph noise: Adding noises into the glyph also serves to make OCR ineffective. FIGS. 4a and 4b illustrate examples of glyph noise. An example of adding glyph noises includes adding white spaces across a character, such as in the example displayed in FIG. 4a. Such white space will not prevent a human user from recognizing the letter “a,” but causes higher recognition error to OCR algorithms. A second example is shown in FIG. 4b, where the letter “a” is accompanied by dotted noises. Such added noise does not incur any readability issues to a human being, but makes OCR ineffective.

Glyph distortion: Another way to render OCR ineffective is to distort the shape of a character. One example of this is shown in FIG. 5, where the letter “a” is changed in shape through glyph distortion.

Note that these examples of glyph distortion, glyph slicing and glyph noise are not exhaustive and serve as examples of glyph and font manipulations that render OCR and manual inspection work-arounds ineffective against preventing copy-and-paste of web content by font obfuscation. They accordingly should not be considered limiting.

Preventing Copy-and-Paste of Text Content by Font Obfuscation

While the methodologies and system presented herein have been directed to web content, they are also applicable to preventing copy-and-pasting of text content.

Text-based documents such as PDF and Microsoft Word documents are commonly used for information exchange. However, there are many scenarios where the content of a document should be read but not copied For instance, a PDF-based book may be copyright-protected, so while a user has access to read the PDF, the user is not allowed to freely select and copy any text of the book and paste the text to another location.

“Encryption” is often used to protect the content of PDF documents. In PDF readers that support such a function, a user creates a password to prevent a PDF document from being copied. However, this function is not standardized across the PDF industry and not every PDF reader honors such protections. For example, a PDF that is password protected can be opened inside the Firefox browser, allowing all the text of the PDF to still be copied. In addition to PDF documents, there is no effective way to protect any other types of text-based documents like Microsoft Word.

The following description shows how to protect content of text-based documents from being copied. When the protection techniques are applied, a user views the content of the document as usual. However, when the user selects and copies the text, then pastes the copied content to somewhere else, the user only obtains and views garbled text instead of the original content displayed in the document.

Again, letters, digits, and special characters, etc., displayed in a text-based document are encoded by encoding schemes like the American Standard Code for Information Interchange (ASCII), which maps a character to a binary value. For example, the character “A” is encoded into “0x41” (the hexadecimal representation of the binary 100 0001) by ASCII. Based on the encoding schemes, fonts have been created to display text with different appearances to accommodate functional and cosmetic needs. A font essentially defines three attributes of a set of characters: the glyphs (i.e., the appearance of characters, such as the image “A”), the codes (e.g., 0x41), and the mapping between the codes and the glyphs (e.g., code 0x41 should be displayed using glyph “A”).

The mapping of a font is easily manipulated by using existing font design tools. For instance, a normal font maps the code 0x41 to the glyph “A”, while this code can be changed to map to the glyph “B” or “C”, or any other glyphs. Essentially, a computer recognizes a character by reading its code, while a human being will recognize the glyph. The embodiments of this disclosure disrupt the “standard” mapping between codes and glyphs so that a human user and computer will recognize a character differently.

For example, if the document owner wants a user to be able to read the word “apple” in the document, but does not want the word to be copied, they create a specific font that maps the code of “x” (0x78) to the glyph of “a”, the code of “y” (0x79) to the glyph of “p”, the code of “m” (0x6D) to the glyph of “I”, and the code of “k” (0x6B) to the glyph of “e”. Then, the document owner will put the code string 0x78 0x79 0x79 0x6D 0x6B into the document, and specify that the specifically designed font, the obfuscated fonts, be used to display those characters.

Further, the document owner enforces the font to be “embedded” into the document. Embedding a font refers to integrating the font into the text document. If a character in a text document uses a specific font and the needed font is embedded in the document, the embedded font is used to display the character; on the other hand, if the font is not embedded, the text editor uses fonts installed in the computer where the document is opened. For this technique to work, the specifically designed font must be embedded into the document that is to be protected.

When this document is opened, the text editor identifies characters to be displayed using the specified font embedded in the document. Thus, the text editor uses a specifically designed font to display the code string 0x78 0x79 0x79 0x6D 0x6B, displaying the string as the word “apple.”

When such a code string is copied and pasted to a different text editor, because the other text editor is not aware of such disrupted code-glyph mapping and will follow standard code-glyph mapping, it will display the glyphs according to the “standard,” such as ASCII, and instead display it as “xyymk.” This action effectively achieves its objective. While a human user can read the content of the document as usual, they cannot copy-and-paste any content displayed in the document.

Note that the above description and example uses PDF as an example, implementations of the disclosure is not so limited. Rather, the disclosure encompasses any and all text-based documents that support owner-specified font and embedding fonts into the document, which includes, but is not limited to Microsoft Word, for example.

Moreover, the above-described techniques of glyph manipulation, including glyph slicing, glyph noise, glyph distortion, etc. shown in FIGS. 1-6, are applicable to prevent the use of OCR and human manual inspection as work-arounds. As previously described, OCR is usually a machine learning-based algorithm that allows a computer to “read” an article and extract characters automatically. In the above-mentioned example, even though a human being is unable to directly copy-and-paste the content of a web page, they can use OCR to read and recognize and extract characters. OCR may be used against either the web page directly or the font file. When being used against the web page, OCR is used to read the article and extract its content directly. When being used against the font file, the OCR is used to read the font file, and recognize the mapping between a code and its corresponding glyph. For example, in the above-mentioned example, the OCR is used to find that code 0x78 is mapped to the letter “a.” Once such disrupted mapping is identified, tools are developed to map all code 0x78 contained in the web page into letter “a.”

Alternately, a human user may manually inspect the font file and find the mapping. A font file may be opened and inspected using available applications, such as FontForge. Based on the above example, a user could download the specifically designed font file, open it, and identify that the code 0x78 is mapped to the letter “a.” And once such mapping is identified, tools may then be developed to map all code 0x78 into letter “a.”

In accordance with various embodiments described herein, various types of glyph distortion are effective to block those two approaches to unauthorized copy-and-pasting of text-based documents.

Glyph slicing: Instead of letting one glyph display one complete character, in accordance with embodiments described herein, one glyph displays a part of a character, and each part of the glyph is assigned or given different codes. For example, in FIG. 2a, letter “a” is sliced into three parts and given codes 0x01, 0x02, and 0x03, respectively. And if the letter “a” is to be displayed, the code string 0x01 0x02 0x03 is sent altogether. This approach significantly increases the cost of manual inspection. Note the font may be sliced in any direction in irregular shape slicing, as shown in FIG. 2b.

Glyph noise: Adding noises into the glyph also serves to make OCR ineffective. FIGS. 4a and 4b illustrate examples of glyph noise. An example of adding glyph noises includes adding white spaces across a character, such as in the example displayed in FIG. 4a. Such white space will not prevent a human user from recognizing the letter “a,” but causes higher recognition error to OCR algorithms. A second example is shown in FIG. 4b, where the letter “a” is accompanied by dotted noises. Such added noise does not incur any readability issues to a human being, but makes OCR ineffective.

Glyph distortion: Another way to render OCR ineffective is to distort the shape of a character. One example of this is shown in FIG. 5, where the letter “a” is changed in shape through glyph distortion.

Note that these examples of glyph distortion, glyph slicing and glyph noise are not exhaustive and serve as examples of glyph and font manipulations that render OCR and manual inspection work-arounds ineffective against preventing copy-and-paste of text-based documents by font obfuscation. They accordingly should not be considered limiting.

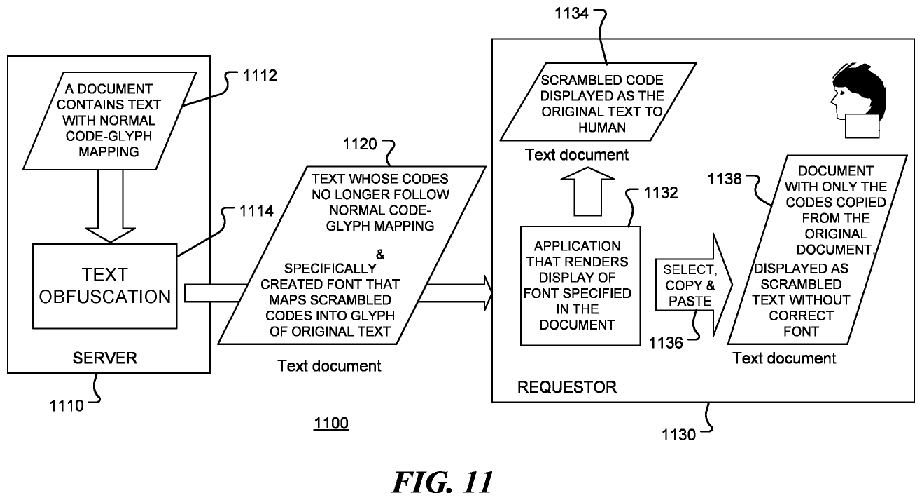

Referring now to FIG. 11, an example block diagram 1100 illustrates the use of obfuscated fonts to protect text documents from being copied and pasted without authorization, in accordance with various embodiments. A requestor 1130, such as a human user, is provided from a server 1110 a text document 820 having obfuscated fonts that maps scrambled codes into glyphs of the original text. As previously described text obfuscation block 1114 of server 1110, which obfuscation may be performed by a web server/content server/data server or a font server, performs obfuscation on an original text document 1112 having normal code-glyph mapping.

The obfuscated text document 1120 is received by an application, such as a text reader, that renders for display the document in the font specified. The text document 1130 has scrambled code of the obfuscated fonts and is readable to the human user. However, the action of selecting, copy and pasting text from obfuscated text document 1120 will not result in a readable text document 1138 for the user.

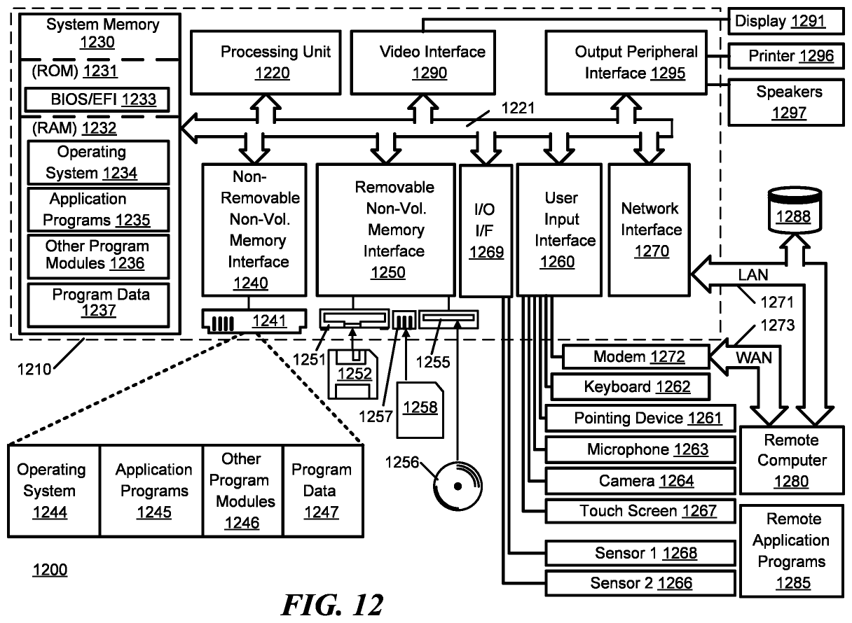

FIG. 12 illustrates an example controller and/or computing environment on which aspects of some embodiments may be implemented. The computing environment 1200 is only one example of a computing environment and is not intended to suggest any limitation as to the scope of use or functionality of the claimed subject matter. Neither should the computing environment 1200 be interpreted as having any dependency or requirement relating to any one or combination of components illustrated in the example operating environment 1200.

Embodiments are operational with numerous other general purpose or special purpose computing system environments or configurations. Examples of well-known computing systems, environments, and/or configurations that may be suitable for use with various embodiments include, but are not limited to, embedded computing systems, personal computers, server computers, mobile devices, hand-held or laptop devices, multiprocessor systems, microprocessor-based systems, set top boxes, programmable consumer electronics, medical device, network PCs, minicomputers, mainframe computers, cloud services, telephonic systems, distributed computing environments that include any of the above systems or devices, and the like.

Embodiments may be described in the general context of computer executable instructions, such as program modules, being executed by computing capable devices. Generally, program modules include routines, programs, objects, components, data structures, etc. that perform particular tasks or implement particular abstract data types. Some embodiments may be designed to be practiced in distributed computing environments where tasks are performed by remote processing devices that are linked through a communications network. In a distributed computing environment, program modules may be located in both local and remote computer storage media including memory storage devices.

With reference to FIG. 12, an example system for implementing some embodiments includes a computing device 1210. Components of computing device 1210 may include, but are not limited to, a processing unit 1220, a system memory 1230, and a system bus 1221 that couples various system components including the system memory to the processing unit 1220.

Computing device 1210 may comprise a variety of computer readable media. Computer readable media may be any available media that can be accessed by computing device 1210 and includes both volatile and nonvolatile media, and removable and non-removable media. By way of example, and not limitation, computer readable media may comprise computer storage media and communication media. Computer storage media may comprise volatile and/or nonvolatile, and/or removable and/or non-removable media implemented in any method or technology for storage of information such as computer readable instructions, data structures, program modules or other data. Computer storage media comprises, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computing device 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media configured to communicate modulated data signal(s). Combinations of any of the above should also be included within the scope of computer readable media.

System memory 1230 includes computer storage media in the form of volatile and/or nonvolatile memory such as ROM 1231 and RAM 1232. A basic input/output system 1233 (BIOS), containing the basic routines that help to transfer information between elements within computing device 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237 that may be stored in RAM 1232.

Computing device 1210 may also include other removable/non-removable volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, a flash drive reader 1257 that reads flash drive 1258, and an optical disk drive 1255 that reads from or writes to a removable, nonvolatile optical disk 1256 such as a Compact Disc Read Only Memory (CD ROM), Digital Versatile Disc (DVD), Blue-ray Disc™ (BD) or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12 provide storage of computer readable instructions, data structures, program modules and other data for computing device 1210. In FIG. 12, for example, hard disk drive 1241 is illustrated as storing operating system 1244, application programs 1245, program data 1247, and other program modules 1246. Additionally, for example, non-volatile memory may include instructions, for example, to discover and configure IT device(s); to create device neutral user interface command(s); combinations thereof, and/or the like.

A user may enter commands and information into computing device 1210 through input devices such as a keyboard 1262, a microphone 1263, a camera 1264, touch screen 1267, and a pointing device 1261, such as a mouse, trackball or touch pad. These and other input devices are often connected to the processing unit 1220 through a user input interface 1260 that is coupled to the system bus, but may be connected by other interface and bus structures, such as a parallel port, a game port and/or a universal serial bus (USB).

Sensors, such as sensor 1 1268 and sensor 2 1266, may be connected to the system bus 1221 via an Input/Output Interface (I/O I/F) 1269. Examples of sensor(s) 1266, 1268 include a microphone, an accelerometer, an inertial navigation unit, a piezoelectric crystal, and/or the like. A monitor 1291 or other type of display device may also be connected to the system bus 1221 via an interface, such as a video interface 1290. Other devices, such as, for example, speakers 1297 and printer 1296 may be connected to the system via peripheral interface 1295.

Computing device 1210 may be operated in a networked environment using logical connections to one or more remote computers, such as a remote computer 1280. The remote computer 1280 may be a personal computer, a mobile device, a hand-held device, a server, a router, a network PC, a medical device, a peer device or other common network node, and typically includes many or all of the elements described above relative to computing device 1210. The logical connections depicted in FIG. 12 include a local area network (LAN) 1271 and a wide area network (WAN) 1273, but may also include other networks such as, for example, a cellular network. Such networking environments are commonplace in offices, enterprise-wide computer networks, intranets and the Internet.

When used in a LAN networking environment, computing device 1210 may be connected to the LAN 1271 through a network interface or adapter 1270. When used in a WAN networking environment, computing device 1210 typically includes a modem 1272 or other means for establishing communications over the WAN 1273, such as the Internet. The modem 1272, which may be internal or external, may be connected to the system bus 1221 via the user input interface 1260, or other appropriate mechanism. The modem 1272 may be wired or wireless. Examples of wireless devices may comprise, but are limited to: Wi-Fi, Near-field Communication (NFC) and Bluetooth™. In a networked environment, program modules depicted relative to computing device 1210, or portions thereof, may be stored in the remote memory storage device 1288. By way of example, and not limitation, FIG. 12 illustrates remote application programs 1285 as residing on remote computer 1280. It will be appreciated that the network connections shown are exemplary and other means of establishing a communications link between the computers may be used. Additionally, for example, LAN 1271 and WAN 1273 may provide a network interface to communicate with other distributed infrastructure management device(s); with IT device(s); with users remotely accessing the User Input Interface 1260; combinations thereof, and/or the like.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method, comprising:
responsive to a request for displayable content having text:
determining a text portion of the requested displayable content to be obfuscated; and
providing a plurality of obfuscated fonts generating the plurality obfuscated fonts from a set of obfuscated glyphs created from a plurality of glyphs representative of a plurality of characters of the text portion of the displayable content, said generating including:
creating the plurality of obfuscated fonts by assigning the obfuscated glyphs of the set into the plurality of obfuscated fonts in accordance with one or more messages; and
mapping the plurality of obfuscated fonts by assigning a value to each obfuscated glyph in the set that is different from an original value of the glyph.

2. The method of claim 1, further comprising mapping one or more characters of displayable content to an identity indicator of a requestor of the displayable content.

3. The method of claim 2, where the identity indicator is one or more of an IP address associated with the requestor and information in a request header of a request sent by the requestor.

4. The method of claim 1, further comprising determining that the request for the displayable content is from an approved requestor, not creating the plurality of obfuscated fonts, and providing the displayable content to the approved requestor without obfuscation of the displayable content.

5. The method of claim 1, further comprising determining that the request for the displayable content is from an approved requestor and providing the plurality of obfuscated fonts and the one or more messages associated with the obfuscated fonts to the approved requestor.

6. The method of claim 1, further comprising rendering the requested displayable content for display in accordance with the plurality of obfuscated fonts.

7. The method of claim 1, where the one or more messages include one or more of a number of chunks into which each glyph of the plurality of glyphs are to be divided, how the plurality of obfuscated glyphs fill the plurality of obfuscated fonts, a number of obfuscated glyphs of the set of obfuscated glyphs, a number of obfuscated glyphs in each obfuscated font, and a value for each obfuscated glyph in each obfuscated font.

8. The method of claim 1, further comprising a server generating the one or more messages using one or more of an identity indicator of a requestor of the displayable content and a shared key between the server and a font server.

9. The method of claim 8, where the requestor is an approved requestor and further comprising the server sharing with the requestor the shared key between the server and the font server, where the requestor can access the displayable content without obfuscated fonts using the identity indicator of the requestor and the shared key.

10. The method of claim 8, where the identity indicator is one or more of an IP address associated with the requestor and information in a request header of a request sent by the requestor.

11. The method of claim 1, further comprising a server communicating to a font server the text portion of the requested displayable content to be obfuscated and determining the one or more messages.

12. The method of claim 1, further comprising:
slicing the plurality of glyphs representative of the plurality of characters to create a slice set of obfuscated glyphs, with each slice in the slice set representative of a portion of a character of the plurality of characters.

13. The method of claim 12, further comprising selecting how each glyph of the one or more glyphs is sliced, including selecting the number of slices in the slice set and selecting the number of obfuscated fonts of the plurality of obfuscated fonts in accordance with the one or more messages.

14. The method of claim 12, where slicing comprises one or more of vertically slicing, horizontally slicing, irregular shape slicing and inserting spaces into one or more glyphs of the plurality of glyphs.

15. The method of claim 12, where the slice set of obfuscated glyphs is chosen from a plurality of slice sets of obfuscated glyphs in accordance with the one or more messages.

16. The method of claim 1, with each glyph of the plurality of glyphs having coordinates that define the glyph and creating the set of obfuscated glyphs includes manipulating the coordinates of one or more of the plurality of glyphs.

17. The method of claim 16, where manipulating the coordinates of one or more of the plurality of glyphs includes changing the coordinates of one or more of the plurality of glyphs and interleaving the coordinates of one or more of the plurality of glyphs.

18. The method of claim 17, where interleaving a glyph of the plurality of glyphs includes interleaving fake coordinates with original coordinates of the glyph.

19. The method of claim 18, further comprising dropping one or more original coordinates of the glyph.

20. The method of claim 1, where the plurality of obfuscated fonts are part of a collection of obfuscated and nonobfuscated glyphs.

21. The method of claim 1, where the value assigned to each obfuscated glyph is a code.

22. The method of claim 1, where the plurality of obfuscated fonts were previously generated and stored and where providing the plurality of obfuscated fonts includes retrieving the plurality of obfuscated fonts from storage.
